(19) United States
(12) Patent Application Publication
(10) Pub. No.: US 2013/0343549 A1
(43) Pub. Date: Dec. 26, 2013

(54) MICROPHONE ARRAYS FOR GENERATING STEREO AND SURROUND CHANNELS, METHOD OF OPERATION THEREOF AND MODULE INCORPORATING THE SAME

(71) Applicant: VeriSilicon Holdings Co., Ltd., Plano, TX (US)

(72) Inventors: Krishna Vemireddy, San Jose, CA (US); Jitendra D. Rayala, Sunnyvale, CA (US)

(21) Appl. No.: 13/932,805

(22) Filed: Jul. 1, 2013

Related U.S. Application Data
(63) Continuation-in-part of application No. 13/531,211, filed on Jun. 22, 2012.

(51) Int. Cl. H04R 5/027

(52) U.S. Cl. CPC H04R 5/027
USPC 381/17

(57) ABSTRACT

A system and method for generating multiple audio channels. In one embodiment, the system includes: (1) an array of omnidirectional microphones and (2) a beamformer coupled to the array and operable to transform signals produced by the array into multiple directional audio channels.

### CROSS-REFERENCE TO RELATED APPLICATION

This application is a continuation-in-part of U.S. patent application Ser. No. 13/531,211, filed by Rayala, et al., on Jun. 22, 2012, entitled “Real-Time Microphone Array With Robust Beamformer and Postfilter for Speech Enhancement and Method of Operation Thereof,” commonly assigned with this application and incorporated herein by reference.

### TECHNICAL FIELD

This application is directed, in general, to microphones arrays and, more specifically, to a microphone array for capturing multiple audio channels.

### BACKGROUND

Audio recording using one-dimensional (1-D) (i.e. linear) or two-dimensional (2-D) (i.e. planar) microphone arrays to capture stereo or surround ambience is a well-established practice (see, e.g., Rayburn, “Eargle's The Microphone Book: From Mono to Stereo to Surround: A Guide to Microphone Design and Application,” Focal Press, 2011; Rumsey, “Spatial Audio,” Focal Press, 2001; Gerzon, “The Design of Precisely Coincident Microphone Arrays for Stereo and Surround Sound,” 50th Audio Engineering Society Convention, London, March 1975; Williams, “Migration of 5.0 Multichannel Microphone Array Design to Higher Order MMAD (6.0, 7.0 & 8.0) With or Without the Inter-format Compatibility Criteria,” Paper 7480, 124^{th} Audio Engineering Society (AES) Convention, May 2008; and Yong, et al., “Sound Source Localization for Circular Arrays of Directional Microphones,” Proc. IEEE ICASSP, pp. 93-96, March 2005. Commercially available 2-D microphone arrays include the Soundfield SPS200 SW controlled microphone from TSL Professional Products Ltd. of Marlow, UK, and the Zoom H2N surround/stereo audio recorder from Samson Technologies of Hauppauge, N.Y., USA. These conventional arrays consist of a few closely spaced bidirectional or unidirectional (e.g., cardioid) microphones and have proven relatively effective in generating multiple audio channels.

### SUMMARY

One aspect provides a system for generating multiple audio channels. In one embodiment, the system includes: (1) an array of omnidirectional microphones and (2) a beamformer coupled to the array and operable to transform signals produced by the array into multiple directional audio channels.

Another aspect provides a method of generating multiple audio channels. In one embodiment, the method includes: (1) producing signals from each of an array of omnidirectional microphones and (2) employing a beamforming technique to transform at least some of the signals into multiple directional audio channels.

Yet another aspect provides a module for an audio recorder/transmitter. In one embodiment, the module includes: (1) a shell, (2) an array of omnidirectional microphones coupled to the shell, (3) a beamformer coupled to the array and operable to transform signals produced by the array into multiple directional audio channels and (4) an interface coupled to the beamformer and operable to convey the multiple directional audio channels into the audio recorder/transmitter.

### BRIEF DESCRIPTION

Reference is now made to the following descriptions taken in conjunction with the accompanying drawings, in which:

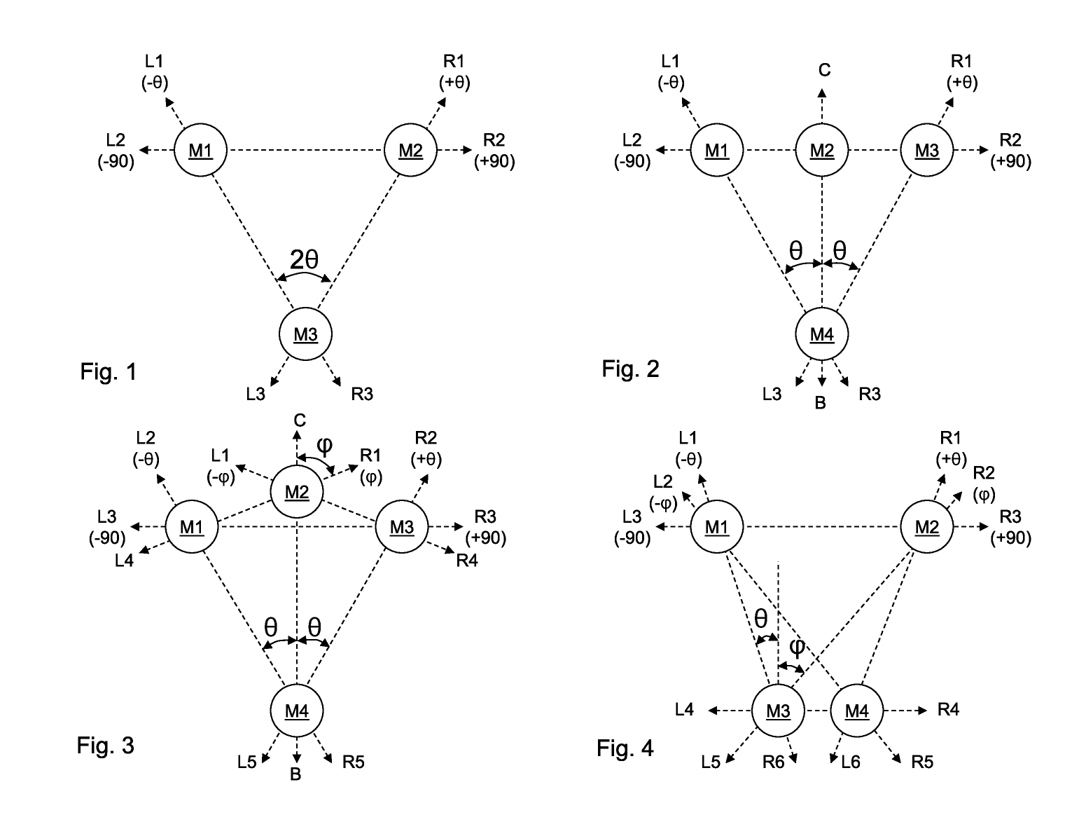

FIG. 1 is a diagram of one embodiment of a three-microphone array;

FIG. 2 is a diagram of a first embodiment of a four-microphone array;

FIG. 3 is a diagram of a second embodiment of a four-microphone array;

FIG. 4 is a diagram of a third embodiment of a four-microphone array;

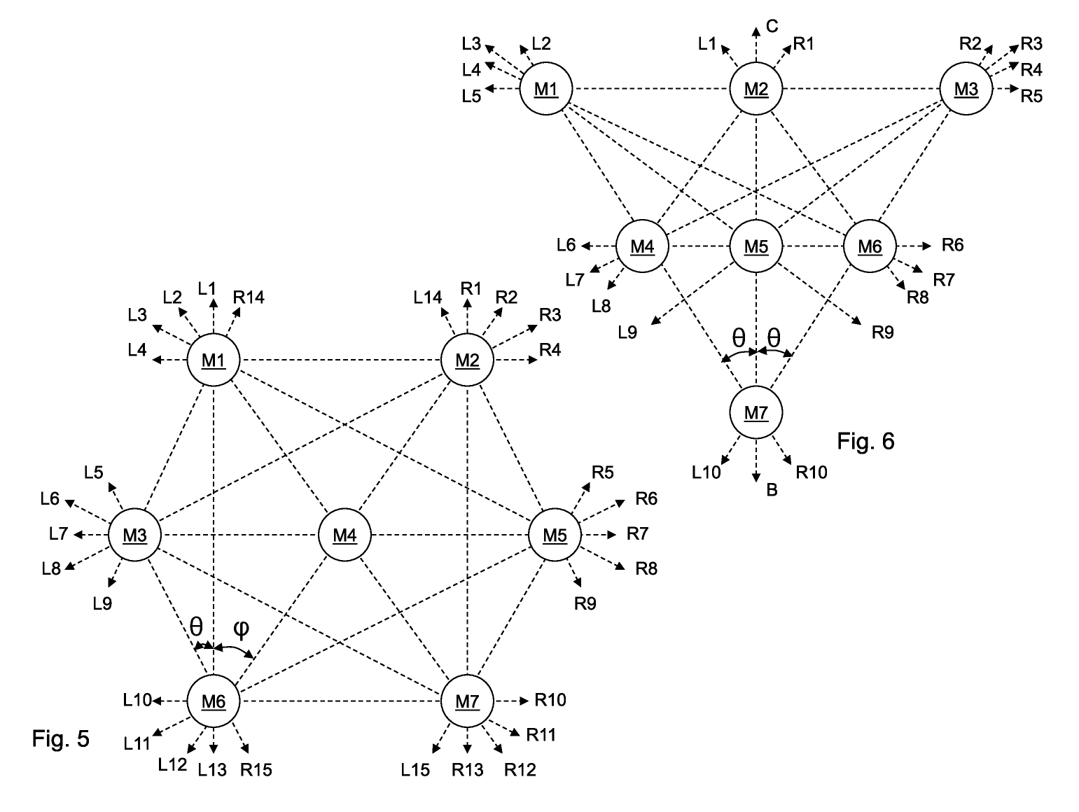

FIG. 5 is a diagram of a first embodiment of a seven-microphone array;

FIG. 6 is a diagram of a second embodiment of a seven-microphone array;

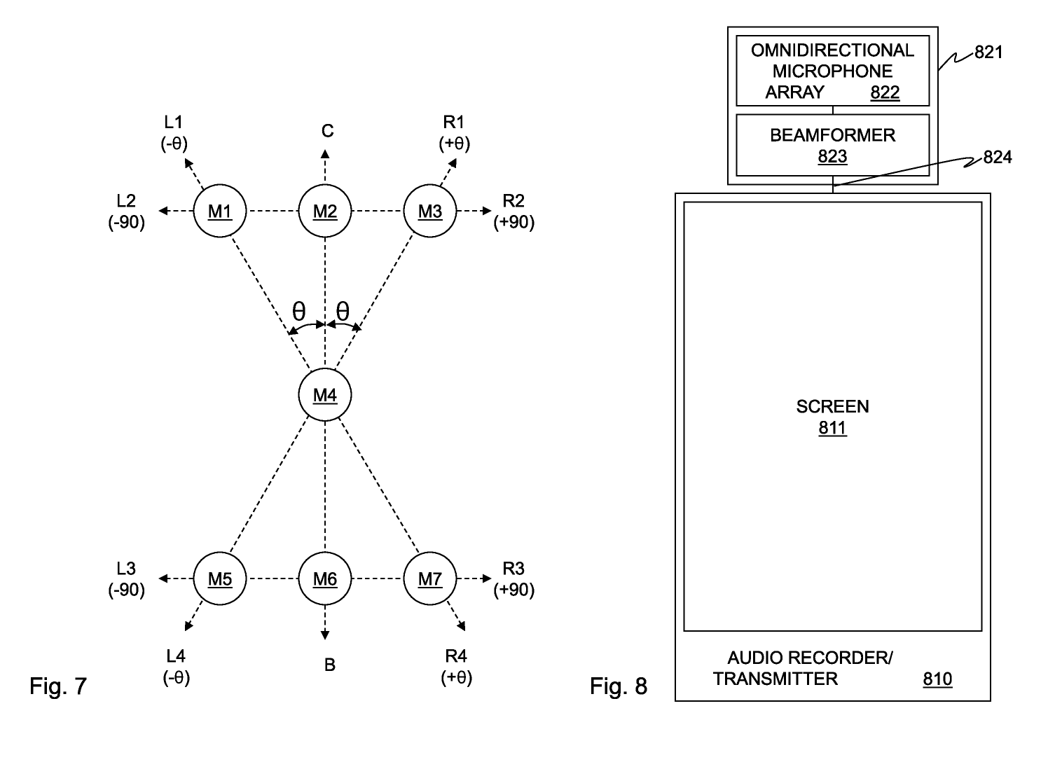

FIG. 7 is a diagram of a third embodiment of a seven-microphone array;

FIG. 8 is a block diagram of one embodiment of a microphone module coupled to an audio recorder/transmitter;

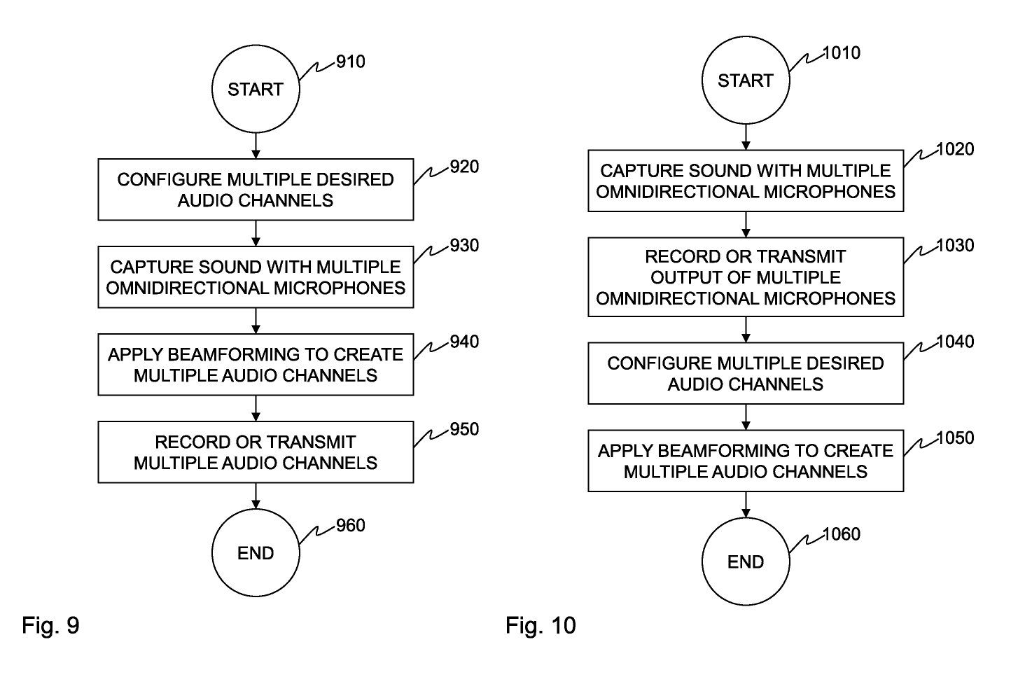

FIG. 9 is a flow diagram of a first embodiment of a method of operating a microphone array to generate stereo or surround channels; and

FIG. 10 is a flow diagram of a second embodiment of a method of operating a microphone array to generate stereo or surround channels.

### DETAILED DESCRIPTION

As stated above, conventional microphone arrays generally consist of a few closely spaced directional (e.g., bidirectional or unidirectional) microphones. Unfortunately, directional microphones suffer from known limitations, including proximity effect and heightened wind noise sensitivity. Low-cost directional microphones are particularly susceptible to off-axis coloration. These shortcomings require compensation, typically taking the form of baffles and high-pass filters. Directional microphones also require proper placement within the array and carefully designed acoustic packaging that allows the directivity to be preserved. All of these contribute to the cost of any product that includes such an array.

It is realized herein that omnidirectional microphones have several advantages over directional microphones, at least in terms of proximity effect and wind noise sensitivity. Further, they do not exhibit off-axis coloration. Some conventional stereo/surround microphone arrays do use omnidirectional microphones. However, these require large spatial dimensions, such as the “Polyhymnia Pentagon” described in Kamekawa, “An Explanation of Various Surround Microphone Techniques,” http://www.sanken-mic.com/en/qanda/index.cfm, or intricately designed acoustic isolation (via baffles and acoustic tubes) between the microphones as in the DPA5100 system described in Nymand, “Developing the 5100 Mobile Surround Mic,” Resolution, April 2009, http://www.dpamicrophones.com/en/Microphone-University/Surround Techniques/-/media/PDF/MicUni/Resolution_{—}5100.pdf. It is thus realized herein that a microphone array employing omnidirectional microphones may have substantial advantages over one employing directional microphones.

Beamforming can be used to provide directivity using as few as two omnidirectional microphones arranged in a closely spaced, end-fire linear array (which may be a “sub-array,” defined as a portion of a larger array). For example, the U.S. patent application on which priority hereof is claimed and incorporated herein by reference teaches various beamforming techniques applicable to omnidirectional microphones. A beamformer to be described below may apply the techniques taught therein or other conventional or later-developed techniques for processing signals produced by various microphone arrays introduced herein.

Microphone beamforming is conventionally employed to suppress directional interference or ambient noise. In the present context however, it is realized herein that microphone beamforming may also be employed to obtain directional response along desired directions.

For XY stereo, desired directivity may be achieved with a pair of cardioid beams having a specified angular separation. For mid-side (MS) stereo, desired directivity may be achieved with a forward-looking cardioid beam and a side-looking bi-directional beam and appropriate mixing. Surround sound acquisition may involve a mix of cardioid, hyper-cardioid or even more directional beams, depending on the microphone and computational resources that are available.

For example, microphone beamforming may be employed to form two cardioid beams in opposite directions along the axis of a dual-microphone end-fire array consisting of a first microphone M1 and a second microphone M2. The array can thus be considered as two virtual arrays: a first sub-array formed by M1-M2, and a second sub-array formed by M2-M1. (This notation will be used throughout this disclosure to denote an ordering of microphones in a sub-array.) Microphone beamforming may be carried out to form these two beams simultaneously; thus they are not mutually exclusive. For applications in which acquisition of stereo or surround audio is required, end-fire arrays leveraging microphone beamforming can be exploited across a variety of 2-D microphone array geometries having multiple microphones. Accordingly, introduced herein are various embodiments of microphone arrays appropriate for yielding multiple audio channels, e.g., stereo or surround audio channels. Various embodiments employ microelectromechanical systems (MEMS) omnidirectional microphones, electret microphones or combinations thereof.

It is realized herein that the inter-microphone spacing between microphones M1 and M2 sets a limit on the highest audio signal frequency beyond which spatial aliasing can occur. The spacing should be less than half the wavelength of the highest frequency signal to be processed. For example, for wideband voice applications where the sampling rate is about 16 KHz, the microphone spacing should be within about 21.2 mm. For full-band (20 KHz) audio applications with sampling rates of 44.1 KHz or 48 KHz, the spacing should be within about 8.5 mm.

Some microphone array embodiments described herein employ a spacing of about 8 mm for at least some microphones in the array embodiments. As a result, certain of the microphone array embodiments may have a relatively compact footprint. In one microphone array embodiment having seven microphones, the footprint is less than 4 cm².

Certain embodiments of the microphone array described herein use different combinations of microphones to capture different frequency bands. As described above, microphone spacing should be within about 8.5 mm to support a full audio bandwidth, nominally defined as about 20 KHz. However, it is realized herein that microphone spacing and directionality bear a direct relationship. Consequently, a relatively close microphone spacing has the effect of reducing the directional performance at low frequencies. Directivity can be improved by increasing the microphone spacing, but higher frequencies will begin to alias, preventing the desired full 20 KHz audio bandwidth from being supported.

It is realized herein that directivity can be preserved, and aliasing resisted by using different combinations of microphones located along the same line. Thus, in various embodiments described herein, two or more microphones having a closer spacing are employed to generate a band of higher frequencies, and two or more microphones having a wider spacing are employed to generate a band of lower frequencies. The two bands can then be combined to yield the desired audio bandwidth. Allocating of microphones between or among multiple bands may be termed “nesting” herein.

FIG. 1 is a diagram of one embodiment of a three-microphone array. A three-microphone array is relatively small and inexpensive due to its having relatively few microphones.

The array has a first microphone M1, second microphone M2 and a third microphone M3 located at vertices of a triangle. The first microphone M1 and the third microphone M3 are operable to provide signals transformable into a first left channel L1 and/or a third right channel R3 (i.e., sub-arrays M1-M3 and M3-M1). The second microphone M2 and the third microphone M3 are operable to provide signals transformable into a first right channel R1 and/or a third left channel L3 (i.e., sub-arrays M2-M3 and M3-M2). The first microphone M1 and the second microphone M2 are operable to provide signals transformable into at least one of a second left channel L2 and/or a second right channel R2.

As FIG. 1 shows, the interior angle of the triangle proximate the third microphone M3, which defines the angular separation between the first left and right channels L1, R1 (and perforce L3, R3), has a magnitude of 2θ. In alternative embodiments, 2θ equals about 60°, about 90°, or about 120°. In still other embodiments, 2θ is of any other value desired to achieve a particular channel separation. In the illustrated embodiment, the other two interior angles of the triangle equal each other in magnitude. In other embodiments, the other two interior angles differ from each other in magnitude.

For front surround, the three-microphone embodiment of FIG. 1 is not capable of generating signals that can be directly beamformed to generate a center channel. However, the first left and right channels L1, R1 may be mixed to synthesize a center channel using a conventional or later-developed mixing technique. Mixing may likewise be employed, for example, to synthesize a back center channel using the third left and right channels L3, R3.

For mid-surround, two XY stereo pairs with different width may be generated. Assuming 2θ equals 90°, the first left and right channels L1, R1 may be obtained using beamforming (sub-arrays M1-M3 and M2-M3, respectively). The second left and right channels L2, R2 having a 180° angular separation may be obtained using microphones (sub-arrays M1-M2 and M2-M1, respectively).

FIG. 2 is a diagram of a first embodiment of a four-microphone array. The array has a first microphone M1, a third microphone M3 and a fourth microphone M4 located at vertices of a triangle. The array further has a second microphone M2 located on a side of the triangle between the first microphone M1 and the third microphone M3. The first microphone M1 and the fourth microphone M4 are operable to provide signals transformable into a first left channel L1 and/or a third right channel R3. The third microphone M3 and the fourth microphone M4 are operable to provide signals transformable into a first right channel R1 and/or a third left channel L3. At least two of the first microphone M1, the second microphone M2 and the third microphone M3 are operable to provide signals transformable into at least one of a second left channel L2 and a second right channel R2. The second microphone M2 and the fourth microphone M4 are operable to provide signals transformable into a center channel C and/or a back center channel B.

As FIG. 2 shows, the interior angle of the triangle proximate the fourth microphone M4, which, again, defines the angular separation between the first left and right channels L1, R1 (and perforce L3, R3), has a magnitude of 2θ. In alternative embodiments, 2θ equals about 60°, about 90° or about 120°. In still other embodiments, 2θ is of any other value desired to achieve a particular channel separation. In the illustrated embodiment, the other two interior angles of the triangle equal each other in magnitude. In other embodiments, the other two interior angles differ from each other in magnitude.

Assuming 2θ equals 90°, a center channel C may be formed using M2-M4. XY stereo operation is possible with 90° or 180° separation. XY-90° stereo may be achieved using microphones M1-M4 for the first left channel L1 and microphones M3-M4 for the first right channel R1. XY-180° stereo may be achieved using sub-array M1-M3 for the second left channel L2 and sub-array M3-M1 for the second right channel R2. MS stereo may be achieved using the center channel (sub-array M2-M4) and a bi-directional response from microphones M1 and M3 (e.g., sub-array M1-M3).

The array of FIG. 2 can also be used to capture multi-channel surround sound by forming beams in the front and rear directions for selected sub-arrays. For example, using the (M3-M4) sub-array we obtain front right surround channel, while the (M4-M3) sub-array yields the rear left surround channel.

FIG. 3 is a diagram of a second embodiment of a four-microphone array. The array has a first microphone M1, a third microphone M3 and a fourth microphone M4 located at vertices of a triangle. The array also has a second microphone M2 located outside the triangle between the first microphone M1 and the third microphone M3. The second microphone M2 and the third microphone M3 are operable to provide signals transformable into a first left channel L1 and/or a fourth right channel R4. The first microphone M1 and the second microphone M2 are operable to provide signals transformable into a first right channel R1 and/or a fourth left channel L4. The first microphone M1 and the fourth microphone M4 are operable to provide signals transformable into a second left channel L2 and/or a fifth right channel R5. The third microphone M3 and the fourth microphone M4 are operable to provide signals transformable into a second right channel R2 and/or a fifth left channel L5. The first microphone M1 and the third microphone M3 are operable to provide signals transformable into at least one of a third left channel L3 and a third right channel R3. The second microphone M2 and the fourth microphone M4 are operable to provide signals transformable into a center channel C and/or a back center channel B.

In the illustrated embodiment, the spacing between microphones M1 and M4, M2 and M4 and M3 and M4 is uniform. In one specific embodiment, the spacing is about 21 mm, which (at a KHz sampling rate) makes the array suitable for wideband voice applications.

As FIG. 3 shows, the interior angle of the triangle proximate the fourth microphone M4, which, again, defines the angular separation between the first left and right channels L2, R2 (and perforce L5, R5), has a magnitude of 2θ. In alternative embodiments, 2θ equals about 60°, about 90° or about 120°. In still other embodiments, 2θ is of any other value desired to achieve a particular channel separation. In the illustrated embodiment, the other two interior angles of the triangle equal each other in magnitude. In other embodiments, the other two interior angles differ from each other in magnitude.

As FIG. 3 shows, φ defines the angular separation between the center channel C and the first right channel R1. Assuming that the angular separation between the center channel C and the first left channel L1 is also φ, the angular separation between the first left and right channels L1, R1 (and perforce L4, R4), has a magnitude of 2φ.

Before describing further microphone array embodiments, it should be noted that the channel nomenclature employed herein (e.g., left, right, center) are relative to an implicit primary axis (often pointing to the subject of a recording, such as an orator or a musical band, or parallel with the optical axis of a lens). Those skilled in the pertinent art should understand that such arrays may be rotated with respect to such primary axis. In such case, while the relative positions of the microphones remains constant, the nomenclature given to the audio channels produced by beamforming would change (e.g., a right channel might become a center channel; a center channel might become a left channel; and so forth). Array rotations will therefore not be further discussed.

FIG. 4 is a diagram of a third embodiment of a four-microphone array. The array has a first microphone M1 and a second microphone M2 located at respective first and the second vertices of a triangle. The array further has a third microphone M3 located on a side of the triangle spanning the first and the third vertices of the triangle and a fourth microphone M4 located on a side of the triangle spanning the second and the third vertices. The first microphone M1 and the third microphone M3 are operable to provide signals transformable into a first left channel L1 and/or a sixth right channel R6. The second microphone M2 and the fourth microphone M4 are operable to provide signals transformable into a first right channel R1 and/or a sixth left channel L6. The first microphone M1 and the fourth microphone M4 are operable to provide signals transformable into a second left channel L2 and/or a fifth right channel R5. The second microphone M2 and the third microphone M3 are operable to provide signals transformable into a second right channel R2 and/or a fifth left channel L5. The first microphone M1 and the second microphone M2 are operable to provide signals transformable into at least one of a third left channel L3 and a third right channel R3.

In FIG. 4, θ+φ defines the angular separation between the first left channel L1 and the second right channel R2. Assuming that the angular separation between the second left channel L2 and the first right channel R1 is also θ+φ, the angular separation between the first left and right channels L1, R1 (and perforce L4, R4), has a magnitude of 2θ, and the angular separation between the second left and right channels L2, R2 (and perforce L5, R5) is 2φ. As is apparent in the trapezoidal array of FIG. 4 yields three different XY stereo separation beams in the forward direction instead of two with the arrays of FIG. 2 and FIG. 3. However, the array of FIG. 4 does not directly provide a center channel. Mixing can be employed to provide a center channel.

XY-180° stereo is obtained using (M1-M2) and (M2-M1) sub-arrays. The other stereo separation angles are determined by θ and φ. For example, these angles can be selected such that array provides L, R stereo pairs at 60°, 120° and 180°.

No further reference will be made to angular separation between channels or linear separation between microphones for the following illustrated embodiments. Those skilled in the pertinent art will understand that wide variations are possible in both without departing from the scope of the invention.

FIG. 5 is a diagram of a first embodiment of a seven-microphone array. The array has a first microphone M1, a second microphone M2, a third microphone M3, a fifth microphone M5, a sixth microphone M6 and a seventh microphone M7 located at vertices of a hexagon. The array further has a fourth microphone M4 located at least proximate a center of the hexagon.

The first microphone M1 and the sixth microphone M6 are operable to provide signals transformable into a first left channel L1 and/or a thirteenth left channel L13. The second microphone M2 and the seventh microphone M7 are operable to provide signals transformable into a first right channel R1 and/or a thirteenth right channel R13. At least two of the first microphone M1, the fourth microphone M4 and the seventh microphone M7 are operable to provide signals transformable into a second left channel L2 and/or a twelfth right channel R12. At least two of the second microphone M2, the fourth microphone M4 and the sixth microphones M6 are operable to provide signals transformable into a second right channel R2 and/or a twelfth left channel L12. The first microphone M1 and the fifth microphone M5 are operable to provide signals transformable into a third left channel L3 and/or an eighth right channel R8. The second microphone M2 and the third microphone M3 are operable to provide signals transformable into a third right channel R3 and/or an eighth left channel L8. The first microphone M1 and the second microphone M2 are operable to provide signals transformable into at least one of a fourth left channel L4 and a fourth right channel R4. The third microphone M3 and the sixth microphone M6 are operable to provide signals transformable into a fifth left channel L5 and/or a fifteenth right channel R15. The fifth microphone M5 and the seventh microphone M7 are operable to provide signals transformable into a fifth right channel R5 and/or a fifteenth left channel L15. The third microphone M3 and the seventh microphone M7 are operable to provide signals transformable into a sixth left channel L6 and/or an eleventh right channel R11.

The fifth microphone M5 and the sixth microphone M6 are operable to provide signals transformable into a sixth right channel R6 and/or an eleventh left channel L11. At least two of the third microphone M3, the fourth microphone M4 and the fifth microphone M5 are operable to provide signals transformable into at least one of a seventh left channel L7 and a seventh right channel R7. The sixth microphone M6 and the seventh microphone M7 are operable to provide signals transformable into at least one of a tenth left channel L10 and a tenth right channel R10. The first microphone M1 and the third microphone M3 are operable to provide signals transformable into a ninth left channel L9 and/or a fourteenth right channel R14. The second microphone M2 and the fifth microphone M5 are operable to provide signals transformable into a ninth right channel R9 and/or a fourteenth left channel L14.

Nesting may be employed to yield different frequency bands. For example, the second left channel L2 may be formed with a combination of an upper frequency band and a lower frequency band in which the first, fourth and seventh microphones M1, M4, M7 form a three-microphone sub-array for the upper frequency band and the first and seventh microphones M1, M7 form a two-microphone sub-array for the lower frequency band. Likewise, the seventh left channel L7 may be formed with a combination of an upper frequency band and a lower frequency band in which the third, fourth and fifth microphones M3, M4, M5 form a three-microphone sub-array for the upper frequency band and the third and fifth microphones M3, M5 form a two-microphone sub-array for the lower frequency band.

FIG. 6 is a diagram of a second embodiment of a seven-microphone array. The array has a first microphone M1, a third microphone M3 and a seventh microphone M7 located at respective first, second and third vertices of a triangle. The array further has a second microphone M2 located on a side of the triangle spanning the first and the second vertices of the triangle, a fourth microphone M4 located on a side of the triangle spanning the first and the third vertices and a sixth microphone M6 located on a side of the triangle spanning the second and the third vertices. The array still further has a fifth microphone M5 located at least proximate a center of the triangle.

The second microphone M2 and the sixth microphone M6 are operable to provide signals transformable into a first left channel L1 and/or an eighth right channel R8. The second microphone M2 and the fourth microphone M4 are operable to provide signals transformable into a first right channel R1 and/or an eighth left channel L8. At least two of the first microphone M1, the fourth microphone M4 and the seventh microphone M7 are operable to provide signals transformable into a second left channel L2 and/or a tenth right channel R10. At least two of the third microphone M3, the sixth microphone M6 and the seventh microphone M7 are operable to provide signals transformable into a second right channel R2 and/or a tenth left channel L10. The first microphone M1 and the fifth microphone M5 are operable to provide signals transformable into a third left channel L3 and/or a ninth right channel R9. The third microphone M3 and the fifth microphone M5 are operable to provide signals transformable into a third right channel R3 and/or a ninth left channel L9. The first microphone M1 and the sixth microphone M6 are operable to provide signals transformable into a fourth left channel L4 and/or a seventh right channel R7. The third microphone M3 and the fourth microphone M4 are operable to provide signals transformable into a fourth right channel R4 and/or a seventh left channel L7. At least two of the first microphone M1, the second microphone M2 and the third microphone M3 are operable to provide signals transformable into at least one of a fifth left channel L5 and a fifth right channel R5. At least two of the fourth microphone M4, the fifth microphone M5 and the sixth microphone M6 are operable to provide signals transformable into at least one of a sixth left channel L6 and a sixth right channel R6. At least two of the second microphone M2, the fifth microphone M5 and the seventh microphone M7 are operable to provide signals transformable into a center channel C and/or a back center channel B.

As with FIG. 5, the microphone array embodiment of FIG. 6 supports nesting. For example, the second left channel L2 may be formed with a combination of an upper frequency band and a lower frequency band in which the first, fourth and seventh microphones M1, M4, M7 form a three-microphone sub-array for the upper frequency band and the first and seventh microphones M1, M7 form a two-microphone sub-array for the lower frequency band. Likewise, the sixth left channel L6 may be formed with a combination of an upper frequency band and a lower frequency band in which the fourth, fifth and sixth microphones M4, M5, M6 form a three-microphone sub-array for the upper frequency band and the fourth and sixth microphones M4, M6 form a two-microphone sub-array for the lower frequency band.

FIG. 7 is a diagram of a third embodiment of a seven-microphone array. The array has a first microphone M1, a third microphone M3 and a fourth microphone M4 located at respective first, second and third vertices of a first triangle. The array further has a fifth microphone M5, a seventh microphone M7 and the fourth microphone M4 at respective first, second and third vertices of a second triangle. The first microphone M1, fourth and seventh microphones located along a first line, and the third microphone M3, the fourth microphone M4 and the fifth microphone M5 are located along a second line. The array further has a second microphone M2 located on a side of the triangle spanning the first and the second vertices of the first triangle and a sixth microphone M6 located on a side of the second triangle spanning the first and the second vertices.

At least two of the first microphone M1, the fourth microphone M4 and the seventh microphone M7 are operable to provide signals transformable into at least a first left channel L1 and/or a fourth right channel R4. At least two of the third microphone M3, the fourth microphone M4 and the fifth microphone M5 are operable to provide signals transformable into a first right channel R1 and/or a fourth left channel L4. At least two of the first microphone M1, the second microphone M2 and the third microphone M3 are operable to provide signals transformable into at least one of a second left channel L2 and a second right channel R2. At least two of the fifth microphone M5, the sixth microphone M6 and the seventh microphone M7 are operable to provide signals transformable into at least one of a third left channel L3 and a third right channel R3. At least two of the second microphone M2, the fourth microphone M4 and the sixth microphone M6 are operable to provide signals transformable into a center channel C and/or a back center channel B.

The “snowflake” configuration of FIG. 7 allows various sub-arrays having three microphones to provide nesting, with its potential for a wider channel bandwidth and/or a better directional response. The array of FIG. 7 can provide up to eight surround channels (front left, front right, side left, side right, back left, back right, front center, back center) directly without any mixing. In applications where six surround channels are sufficient (front and back center channels excluded) a five-microphone array can be deployed instead, by eliminating microphones M2 and M6.

FIG. 8 is a block diagram of one embodiment of a microphone module coupled to an audio recorder/transmitter 810. In the illustrated embodiment, the audio recorder/transmitter 810 is a “Smartphone” (a mobile phone built on a mobile operating system) such as an iPhone® commercially available from Apple Incorporated of Cupertino, Calif., or an Android-based phone commercially available from a variety of manufacturers now or other mobile devices in future. In alternative embodiments, the audio recorder/transmitter 810 is a camcorder, a video or audio recorder, or a wired/wireless transmitter lacking recording capability.

The module includes a shell 821. Coupled to the shell 821 is an array of omnidirectional microphones 822. A beamformer 823 is coupled to the array 822. The beamformer 823 is operable to transform signals produced by the array 822 into multiple directional audio channels. An interface 824 is coupled to the beamformer 823. The interface 824 is operable to convey the multiple directional audio channels into the audio recorder/transmitter 810. The audio recorder/transmitter 810 may then record or transmit the multiple directional audio channels. In an alternative embodiment, the audio recorder/transmitter 810 may record the “raw” signals produced by the array for subsequent beamforming, as will now be explained. In various alternative embodiments, the interface 824 is or includes a Universal Serial Bus (USB) interface, an IEEE 1394 High Speed Serial Bus interface, a Bluetooth/WiFi wireless link interface, a proprietary (e.g., iPhone) bus interface, a read/write buffer memory interface (e.g., Advanced Microcontroller Bus Architecture (AMBA) High Performance Bus (AHB) or Advanced eXtensible Interface (AXI)) or a system-on-a-chip (SoC) interconnect. The interface 824 may be of any conventional or later-developed type.

FIG. 9 is a flow diagram of a first embodiment of a method of operating a microphone array to generate stereo or surround channels. The embodiment of FIG. 9 generally involves the recording or transmission of the beamformed audio channels rather than the raw signals produced by a given microphone array. The method begins in a start step 910. In a step 920, multiple desired audio channels are configured. In a step 930, sound is captured with multiple omnidirectional microphones. In a step 940, beamforming is applied to create multiple audio channels. In a step 950, the resulting multiple audio channels are recorded or transmitted. The method ends in an end step 960.

FIG. 10 is a flow diagram of a second embodiment of a method of operating a microphone array to generate stereo or surround channels. The embodiment of FIG. 10 generally involves the recording or transmission of the raw microphone signals produced by a given microphone array rather than the beamformed audio channels. While this may require more storage or bandwidth, the same raw microphone output may be subsequently beamformed in different ways to yield different audio channels. The method begins in a start step 1010. In a step 1020, sound is captured with multiple omnidirectional microphones. In a step 1030, the output of multiple omnidirectional microphones is recorded or transmitted. In a step 1040, multiple desired audio channels are configured. In a step 1050, beamforming is applied to create multiple audio channels. The method ends in an end step 1060.

Those skilled in the art to which this application relates will appreciate that other and further additions, deletions, substitutions and modifications may be made to the described embodiments.

What is claimed is:

1. A system for generating multiple audio channels, comprising:
an array of omnidirectional microphones; and
a beamformer coupled to said array and operable to transform signals produced by said array into multiple directional audio channels.

2. The system as recited in claim 1 wherein said multiple directional audio channels are left and right audio channels.

3. The system as recited in claim 1 wherein said multiple directional audio channels include front left, front right, center, back left and back right channels.

4. The system as recited in claim 1 wherein said array includes three microphones located along a line, said beamformer further operable to extract a lower band of frequencies from a more distal pair of said three microphones and a higher band of frequencies from a more proximal pair of said three microphones.

5. The system as recited in claim 1 wherein said array has first, second and third microphones located at vertices of a triangle, said first and said third microphones operable to provide signals transformable into at least a first left channel, said second and said third microphones operable to provide signals transformable into at least a first right channel, said first and said second microphones operable to provide signals transformable into at least one of a second left channel and a second right channel.

6. The system as recited in claim 1 wherein said array has first, third and fourth microphones located at vertices of a triangle and a second microphone located on a side of said triangle between said first and said third microphones, said first and said fourth microphones operable to provide signals transformable into at least a first left channel, said third and said fourth microphones operable to provide signals transformable into at least a first right channel, at least two of said first, said second and said third microphones operable to provide signals transformable into at least one of a second left channel and a second right channel, said second and said fourth microphones operable to provide signals transformable into at least a center channel.

7. The system as recited in claim 1 wherein said array has first, third and fourth microphones located at vertices of a triangle and a second microphone located outside said triangle between said first and said third microphones, said second and said third microphones operable to provide signals transformable into at least a first left channel, said first and said second microphones operable to provide signals transformable into at least a first right channel, said first and said fourth microphones operable to provide signals transformable into at least a second left channel, said third and said fourth microphones operable to provide signals transformable into at least a second right channel, said first and said third microphones operable to provide signals transformable into at least one of a third left channel and a third right channel, said second and said fourth microphones operable to provide signals transformable into at least a center channel.

8. The system as recited in claim 1 wherein said array has first and second microphones located at respective first and said second vertices of a triangle, a third microphone located on a side of said triangle spanning said first and said third vertices of said triangle and a fourth microphone located on a side of said triangle spanning said second and said third vertices, said first and said third microphones operable to provide signals transformable into at least a first left channel, said second and said fourth microphones operable to provide signals transformable into at least a first right channel, said first and said fourth microphones operable to provide signals transformable into at least a second left channel, said second and said third microphones operable to provide signals transformable into at least a second right channel, said first and said second microphones operable to provide signals transformable into at least one of a third left channel and a third right channel.

9. The system as recited in claim 1 wherein said array has first, second, third, fifth, sixth and seventh microphones located at vertices of a hexagon and a fourth microphone located at least proximate a center of said hexagon, said first microphone and said sixth microphone operable to provide signals transformable into at least a first left channel, said second microphone and said seventh microphone operable to provide signals transformable into at least a first right channel, at least two of said first microphone, said fourth microphone and said seventh microphone operable to provide signals transformable into at least a second left channel, at least two of said second microphone, said fourth microphone and said sixth microphones operable to provide signals transformable into at least a second right channel, said first microphone and said fifth microphone operable to provide signals transformable into at least a third left channel, said second microphone and said third microphone operable to provide signals transformable into at least a third right channel, said first microphone and said second microphone operable to provide signals transformable into at least one of a fourth left channel and a fourth right channel, said third microphone and said sixth microphone operable to provide signals transformable into at least a fifth left channel, said fifth microphone and said seventh microphone operable to provide signals transformable into at least a fifth right channel, said third microphone and said seventh microphone operable to provide signals transformable into at least a sixth left channel, said fifth microphone and said sixth microphone operable to provide signals transformable into at least a sixth right channel, at least two of said third microphone, said fourth microphone and said fifth microphone operable to provide signals transformable into at least one of a seventh left channel and a seventh right channel, said sixth microphone and said seventh microphone operable to provide signals transformable into at least one of a tenth left channel and a tenth right channel.

10. The system as recited in claim 1 wherein said array has first, third and seventh microphones located at respective first, second and third vertices of a triangle, a second microphone located on a side of said triangle spanning said first and said second vertices of said triangle, a fourth microphone located on a side of said triangle spanning said first and said third vertices, a sixth microphone located on a side of said triangle spanning said second and said third vertices and a fifth microphone located at least proximate a center of said triangle, said second microphone and said sixth microphone operable to provide signals transformable into at least a first left channel, said second microphone and said fourth microphone operable to provide signals transformable into at least a first right channel, at least two of said first microphone, said fourth microphone and said seventh microphone operable to provide signals transformable into at least a second left channel, at least two of said third microphone, said sixth microphone and said seventh microphone operable to provide signals transformable into at least a second right channel, said first microphone and said fifth microphone operable to provide signals transformable into at least a third left channel, said third microphone and said fifth microphone operable to provide signals transformable into at least a third right channel, said first microphone and said sixth microphone operable to provide signals transformable into at least a fourth left channel, said third microphone and said fourth microphone operable to provide signals transformable into at least a fourth right channel, at least two of said first microphone, said second microphone and said third microphone operable to provide signals transformable into at least one of a fifth left channel and a fifth right channel, at least two of said fourth microphone, said fifth microphone and said sixth microphone operable to provide signals transformable into at least one of a sixth left channel and a sixth right channel, at least two of said second microphone, said fifth microphone and said seventh microphone operable to provide signals transformable into at least a center channel.

11. The system as recited in claim 1 wherein said array has first, third and fourth microphones located at respective first, second and third vertices of a first triangle and fifth, seventh and said fourth microphones at respective first, second and third vertices of a second triangle, said first, fourth and seventh microphones located along a first line and said third, fourth and fifth microphones located along a second line, said array further having a second microphone located on a side of said triangle spanning said first and said second vertices of said first triangle and a sixth microphone located on a side of said second triangle spanning said first and said second vertices, at least two of said first, said fourth and said seventh microphones operable to provide signals transformable into at least a first left channel, at least two of said third, said fourth and said fifth microphones operable to provide signals transformable into at least a first right channel, at least two of said first, said second and said third microphones operable to provide signals transformable into at least one of a second left channel and a second right channel, at least two of said fifth, said sixth and said seventh microphones operable to provide signals transformable into at least one of a third left channel and a third right channel, at least two of said second, said fourth and said sixth microphones operable to provide signals transformable into at least a center channel.

12. A method of generating multiple audio channels, comprising:
producing signals from each of an array of omnidirectional microphones; and
employing a beamforming technique to transform at least some of said signals into multiple directional audio channels.

13. The method as recited in claim 12 wherein said multiple directional audio channels are left and right audio channels.

14. The method as recited in claim 12 wherein said multiple directional audio channels include front left, front right, center, back left and back right channels.

15. The method as recited in claim 12 wherein said array includes three microphones located along a line, said employing comprising:
extract a lower band of frequencies from a more distal pair of said three microphones; and
extracting a higher band of frequencies from a more proximal pair of said three microphones.

16. The method as recited in claim 12 wherein said array has first, second and third microphones located at vertices of a triangle, said producing comprising:
providing signals transformable into at least a first left channel from using first and said third microphones;
providing signals transformable into at least a first right channel using said second and said third microphones; and
providing signals transformable into at least one of a second left channel and a second right channel using said first and said second microphones.

17. The method as recited in claim 12 wherein said array has first, third and fourth microphones located at vertices of a triangle and a second microphone located on a side of said triangle between said first and said third microphones, said producing comprising:
producing signals transformable into at least a first left channel using said first and said fourth microphones;
producing signals transformable into at least a first right channel using said third and said fourth microphones;
producing signals transformable into at least one of a second left channel and a second right channel using at least two of said first, said second and said third microphones; and
producing signals transformable into at least a center channel using said second and said fourth microphones.

18. The method as recited in claim 12 wherein said array has first, third and fourth microphones located at vertices of a triangle and a second microphone located outside said triangle between said first and said third microphones, said producing comprising:
producing signals transformable into at least a first left channel using said second and said third microphones;
producing signals transformable into at least a first right channel using said first and said second microphones;
producing signals transformable into at least a second left channel using said first and said fourth microphones;
producing signals transformable into at least a second right channel using said third and said fourth microphones;
producing signals transformable into at least one of a third left channel and a third right channel using said first and said third microphones; and
producing signals transformable into at least a center channel using said second and said fourth microphones.

19. The method as recited in claim 12 wherein said array has first and second microphones located at respective first and said second vertices of a triangle, a third microphone located on a side of said triangle spanning said first and said third vertices of said triangle and a fourth microphone located on a side of said triangle spanning said second and said third vertices, said producing comprising:
producing signals transformable into at least a first left channel using said first and said third microphones;
producing signals transformable into at least a first right channel using said second and said fourth microphones;
producing signals transformable into at least a second left channel using said first and said fourth microphones;
producing signals transformable into at least a second right channel using said second and said third microphones; and
producing signals transformable into at least one of a third left and a third right channel using said first and said second microphones.

20. The method as recited in claim 12 wherein said array has first, second, third, fifth, sixth and seventh microphones located at vertices of a hexagon and a fourth microphone located at least proximate a center of said hexagon, said producing comprising:
producing signals transformable into at least a first left channel using said first microphone and said sixth microphone;
producing signals transformable into at least a first right channel using said second microphone and said seventh microphone;
producing signals transformable into at least a second left channel using at least two of said first microphone, said fourth microphone and said seventh microphone;
producing signals transformable into at least a second right channel using at least two of said second microphone, said fourth microphone and said sixth microphones;
producing signals transformable into at least a third left channel using said first microphone and said fifth microphone;
producing signals transformable into at least a third right channel said second microphone and said third microphone;
producing signals transformable into at least one of a fourth left channel and a fourth right channel using said first microphone and said second microphone;
producing signals transformable into at least a fifth left channel using said third microphone and said sixth microphone;
producing signals transformable into at least a fifth right channel using said fifth microphone and said seventh microphone;
producing signals transformable into at least a sixth left channel using said third microphone and said seventh microphone;
producing signals transformable into at least a sixth right channel using said fifth microphone and said sixth microphone;
producing signals transformable into at least one of a seventh left channel and a seventh right channel using at least two of said third microphone, said fourth microphone and said fifth microphone; and
producing signals transformable into at least one of a tenth left channel and a tenth right channel using said sixth microphone and said seventh microphone.

21. The method as recited in claim 12 wherein said array has first, third and seventh microphones located at respective first, second and third vertices of a triangle, a second microphone located on a side of said triangle spanning said first and said second vertices of said triangle, a fourth microphone located on a side of said triangle spanning said first and said third vertices, a sixth microphone located on a side of said triangle spanning said second and said third vertices and a fifth microphone located at least proximate a center of said triangle, said producing comprising:
producing signals transformable into at least a first left channel using said second microphone and said sixth microphone;
producing signals transformable into at least a first right channel using said second microphone and said fourth microphone;
producing signals transformable into at least a second left channel using at least two of said first microphone, said fourth microphone and said seventh microphone;
producing signals transformable into at least a second right channel using at least two of said third microphone, said sixth microphone and said seventh microphone;
producing signals transformable into at least a third left channel using said first microphone and said fifth microphone;
producing signals transformable into at least a third right channel using said third microphone and said fifth microphone;
producing signals transformable into at least a fourth left channel using said first microphone and said sixth microphone;
producing signals transformable into at least a fourth right channel using said third microphone and said fourth microphone;
producing signals transformable into at least one of a fifth left channel and a fifth right channel using at least two of said first microphone, said second microphone and said third microphone;
producing signals transformable into at least one of a sixth left channel and a sixth right channel using at least two of said fourth microphone, said fifth microphone and said sixth microphone; and
producing signals transformable into at least a center channel using at least two of said second microphone, said fifth microphone and said seventh microphone.

22. The method as recited in claim 12 wherein said array has first, third and fourth microphones located at respective first, second and third vertices of a first triangle and fifth, seventh and said fourth microphones at respective first, second and third vertices of a second triangle, said first, fourth and seventh microphones located along a first line and said third, fourth and fifth microphones located along a second line, said array further having a second microphone located on a side of said triangle spanning said first and said second vertices of said first triangle and a sixth microphone located on a side of said second triangle spanning said first and said second vertices, said producing comprising:
producing signals transformable into at least a first left channel using at least two of said first, said fourth and said seventh microphones;
producing signals transformable into at least a first right channel using at least two of said third, said fourth and said fifth microphones;
producing signals transformable into at least one of a second left channel and a second right channel using at least two of said first, said second and said third microphones;
producing signals transformable into at least one of a third left channel and a third right channel using at least two of said fifth, said sixth and said seventh microphones; and
producing signals transformable into at least a center channel using at least two of said second, said fourth and said sixth microphones.

23. A module for an audio recorder/transmitter, comprising:
a shell;
an array of omnidirectional microphones coupled to said shell;
a beamformer coupled to said array and operable to transform signals produced by said array into multiple directional audio channels; and
an interface coupled to said beamformer and operable to convey said multiple directional audio channels into said audio recorder/transmitter.

24. The module as recited in claim 23 wherein said interface is selected from the group consisting of:
a Universal Serial Bus interface,
an IEEE 1394 High Speed Serial Bus interface,
a Bluetooth/WiFi wireless link interface,
a proprietary bus interface,
read/write buffer memory interface, and
a system-on-a-chip (SoC) interconnect.

25. The module as recited in claim 23 wherein said audio recorder/transmitter is selected from the group consisting of:
a Smartphone, and
a video camera, and
a standalone voice/audio recorder.
